(19) United States
(12) Patent Application Publication
(10) Pub. No.: US 2014/0180742 A1
(43) Pub. Date: Jun. 26, 2014

(54) Selective locking of business object data structures

(71) Applicants: Herbert Hackmann, Wiesloch (DE); Hardeep Singh, Wiesloch (DE); Fawaz Mohamed Ibrahim, Heidelberg (DE); Christian Seitel, Sandhausen (DE)

(72) Inventors: Herbert Hackmann, Wiesloch (DE); Hardeep Singh, Wiesloch (DE); Fawaz Mohamed Ibrahim, Heidelberg (DE); Christian Seitel, Sandhausen (DE)

(21) Appl. No.: 13/723,589

(22) Filed: Dec. 21, 2012

(51) Int. Cl. G06Q 10/06

(52) U.S. Cl. CPC G06Q 10/063114
USPC 705/7.15

(57) ABSTRACT

A respective transaction associated with at least one business object is initiated on behalf of each of a plurality of users during an interaction phase. Subsequently, an optimistic lock to the business object is assigned to each user during pendency of the corresponding transaction upon modification of at least one node of the at least one business object. An exclusive lock is then assigned to the at least one business object to a first user that first completes the interaction phase. Thereafter and in response to the exclusive lock being assigned, users other than the first user are prevented from obtaining an exclusive lock to the at least one business object in response to the exclusive lock being assigned. Related apparatus, systems, techniques and articles are also described.

### TECHNICAL FIELD

The subject matter described herein relates to selectively locking business object data structures or portions thereof in connection with transactions concurrently executed by a plurality of users.

### BACKGROUND

Complex business applications can be tailored into business objects to encapsulate semantically related functionality and structure. A business object can include a hierarchy of business object nodes, which represent data as attributes. In addition, a business can be an independently viable entity with identifiable instances as well as bundle functions and data, both of which may be accessible from outside of the business object. Business objects can be described by a data model, an internal process model, and one or more typed service interfaces, and can be a core structuring element of applications that are centrally defined by a developer as part of an overall governance process.

Business object services can be consumed by external consuming entities or by other business objects during a transaction. In this regard, a transaction is a set of operations which are indivisible and must be executed together and completely. Conflicts can occur when multiple users are concurrently modifying values associated with business objects, thus affecting the corresponding transactions.

### SUMMARY

In aspect, a respective transaction associated with at least one business object is initiated on behalf of each of a plurality of users during an interaction phase. Each business object includes a plurality of hierarchically related nodes storing values and each transaction is initiated via a service interface of the at least one business object and includes a set of operations that are required to be executed together (with at least one of the operations requiring modification of the at least one business object). Subsequently, an optimistic lock to the business object is assigned to each user during pendency of the corresponding transaction upon modification of at least one node of the at least one business object. An exclusive lock is then assigned to the at least one business object to a first user that first completes the interaction phase. Thereafter and in response to the exclusive lock being assigned, users other than the first user are prevented from obtaining an exclusive lock to the at least one business object in response to the exclusive lock being assigned.

Data can be provided to each user having an assigned optimistic lock other than the first user that indicates that an exclusive lock has been assigned. Providing data can include, for example, displaying a message to each user having an assigned optimistic lock other than the first user.

The interaction phase can be completed when results of business object services executed during the interaction phase via the service interface are saved. All optimistic and exclusive locks, if any, can be released when the results of the business object services are saved. The interaction phase can additionally or alternatively be completed when results of business object services executed during the interaction phase via the service interface are cleaned up. In some cases, there can be more than one exclusive lock and in such cases the exclusive locks can be transformed to optimistic locks once the first user is assigned the exclusive lock.

At least one of the optimistic locks can be for a subset of the nodes of the business object with the other nodes of the at least one business object not being locked. Each business object can have an associated at least one lock shadow such that each lock shadow defines a group of at least two nodes that must be concurrently locked. In some variations, the transaction is associated with two or more business objects.

Computer program products are also described that comprise non-transitory computer readable media storing instructions, which when executed one or more data processor of one or more computing systems, causes at least one data processor to perform operations herein. Similarly, computer systems are also described that may include one or more data processors and a memory coupled to the one or more data processors. The memory may temporarily or permanently store instructions that cause at least one processor to perform one or more of the operations described herein. In addition, methods can be implemented by one or more data processors either within a single computing system or distributed among two or more computing systems.

The subject matter described herein provides many advantages. For example, the current subject matter provides a mechanism to resolve conflicting modifications to a business object as part of multiple concurrent transactions.

The details of one or more variations of the subject matter described herein are set forth in the accompanying drawings and the description below. Other features and advantages of the subject matter described herein will be apparent from the description and drawings, and from the claims.

### DESCRIPTION OF DRAWINGS

FIG. 1 is a process flow diagram illustrating an architecture for implementing selective locking of business object data structures, according to one or more variations;

FIG. 2 is a diagram illustrating a transaction, according to one or more variations;

FIG. 3 is diagram illustrating an interaction phase of the transaction of FIG. 2, according to one or more variations;

FIG. 4 is a diagram illustrating a plurality of users interacting with one or more values encapsulated by a business object data structure, according to one or more variations;

FIG. 5 is a diagram illustrating users having locks on at least a portion of the business object data structure of FIG. 4, according to one or more variations;

FIG. 6 is a diagram illustrating a lock shadow for a portion of a business object data structure, according to one or more variations;

FIG. 7 is code illustrating three separate transactions to create a new sales order instance, according to one or more variations; and

FIG. 8 is a process flow diagram illustrating selectively locking of business object data structures, according to one or more variations.

Like reference symbols in the various drawings indicate like elements.

### DETAILED DESCRIPTION

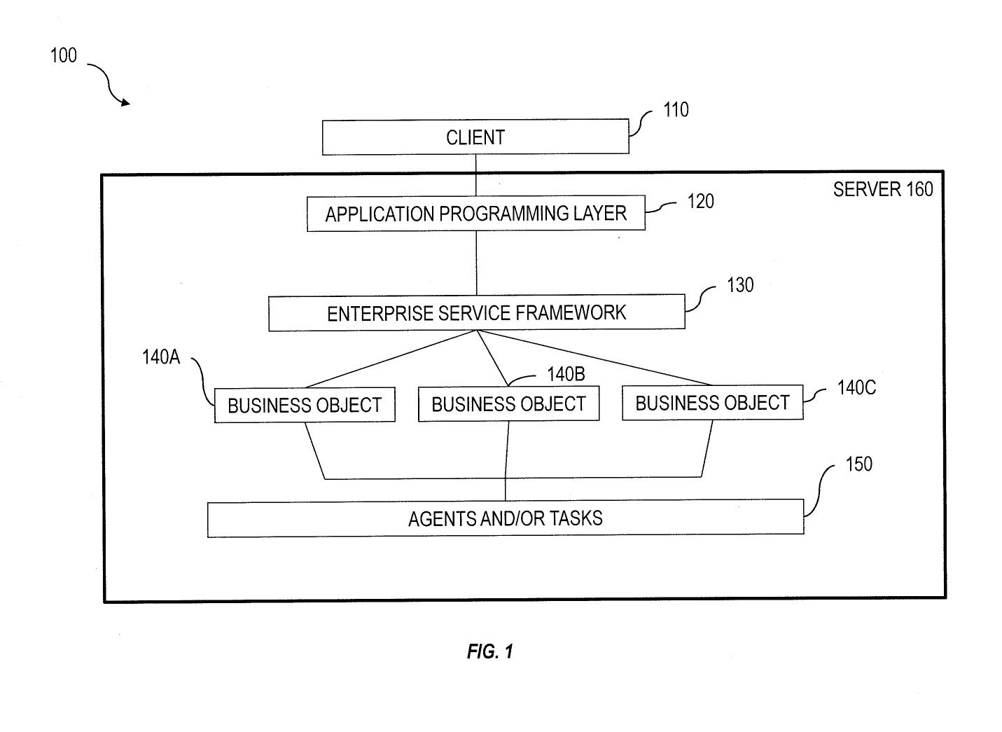

FIG. 1 illustrates a system 100 for processing of data structures, such as business object data structures (also referred to herein as “business objects” or “business object instances”). The system 100 can process and store business object data (e.g., the data fields of a business object). Examples of processing can include: determining consistency of data of a data object, such as a business object including data; performing saving procedures to store data within a database and/or a repository; performing updates to data that can be in a business object (e.g., updates due to newly created, entered, and/or saved data); and performing any other tasks that can manipulate, maintain and/or store data in the data objects. The system 100 can be used to process various business objects (e.g., data structured according to a task, such as sales orders, purchase orders, etc.).

A client application 110 can be used to enter, modify, update, etc. various data that can be processed and eventually passed onto a business object 140 for storage, retrieval, etc. The client application 110 can interact with an application processing layer 504 (such as those encoded in the Advanced Business Application Programming (ABAP) language) for the purposes of processing the data, such as, creation of sales orders, writing and editing reports and module pools, processing database table definitions, designing user interfaces, designing screens and flow logic, building function modules, etc.

The server 160 can be implemented as at least one processor and at least one memory and can include the application processing layer 120, an enterprise services framework 130, business objects 140, and agents 150.

The application processing layer 120 can interact with a framework (e.g., an enterprise service framework (“ESF”) 130), which in turn, can be configured to interact with at least one business object 140. An example of an ESF is commercially available from SAP AG, Walldorf, Germany. The term “framework” can refer to a system of interrelated components, such as programs and the like, providing a business system for performing business functions. The ESF 130 can abstract the business objects, which can be modeled as services (also referred to as enterprise services) providing, for example, purchase order generation, sales order generation, and the like. Aggregating services into business-level enterprise services can provide more meaningful building blocks for the task of automating enterprise-scale business scenarios.

The ESF 130 can include a persistence repository for storing relevant pre-existing enterprise services, which can be made available to selected users. By using a repository, these selected users can use the pre-existing enterprise services to aid in the implementation of new services and corresponding business objects 140. As noted, the business object can represent an object, such as a data structure including data and operations, of significance to a business. Examples of business objects can include a purchase order, a sales order, a flight reservation, a shipping order, customer information, employee information, and the like. A service can thus provide an interface to enable other services and applications to access and process (e.g., create, fill-in, save, query, delete, print, send, and the like) the business object 140.

Business objects 140 and data related to business objects can be stored in a storage mechanism, such as a database or any other persistent storage repository. The system 100 can include an agent 150, which can be initiated upon receipt of data related to the business objects 140. For example, agent 150 can be used to perform various tasks, such as update information related to business objects stored in the database, further process the data, determine the order of storing the data, perform various database update tasks, etc. In some implementations, agents can serve as a bridge or a proxy for tasks, which can be executed after an initial task has been completed. In this case, agents can collect data and transform it in such a way so that the tasks can be processed later on by other components in the system 100. Agents can be configured to generate a message as output, where the message is provided to components in the system 100.

The enterprise service framework 130 can generate a message indicating that the data that the client 110 entered has been successfully saved in the system 100. In addition, the enterprise service framework 130 can generate a message indicating that the data that the client 110 entered was not saved and/or that such data is locked. Such messages can be presented to the client 110 via a user interface in the form of a message, such as a Hypertext Markup Language (“HTML”) message. In some implementations, if a sales order object is being created and saved by the client 110, the HTML message indicating successful storage of the data can also include a sales order number, which can confirm that a particular sales order has been created and saved to the system 100. In some implementations, the message can be presented by automatically updating of the client's user interface, or by sending an email, an instant message, a text message, a multimedia message, etc. to the client 110, or in any other form. In order to save the business object data to the system 100, the system 100 can be configured to perform a save-and-exit procedure.

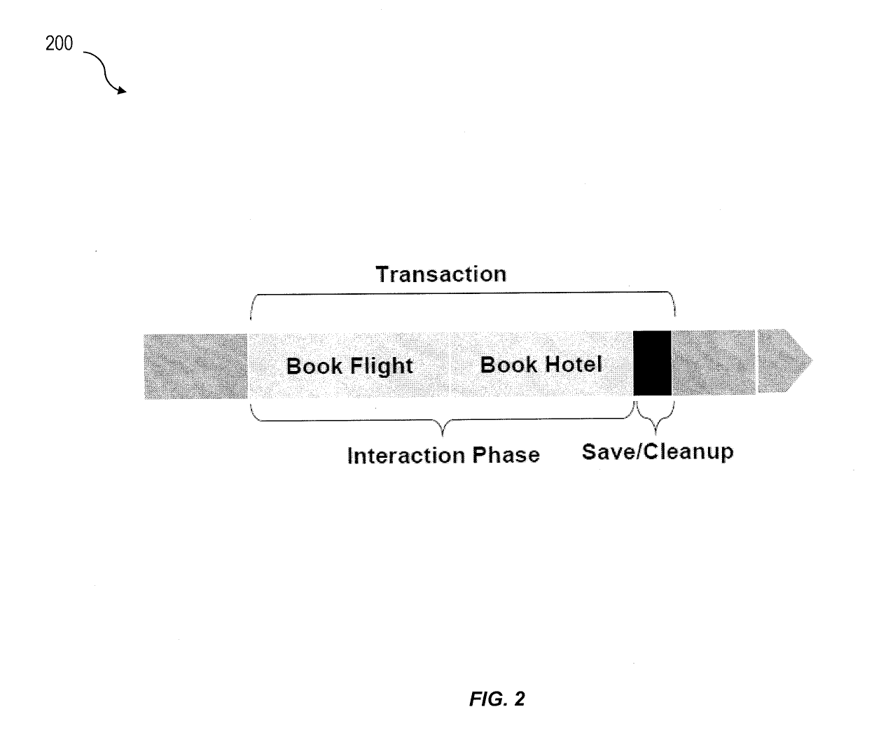

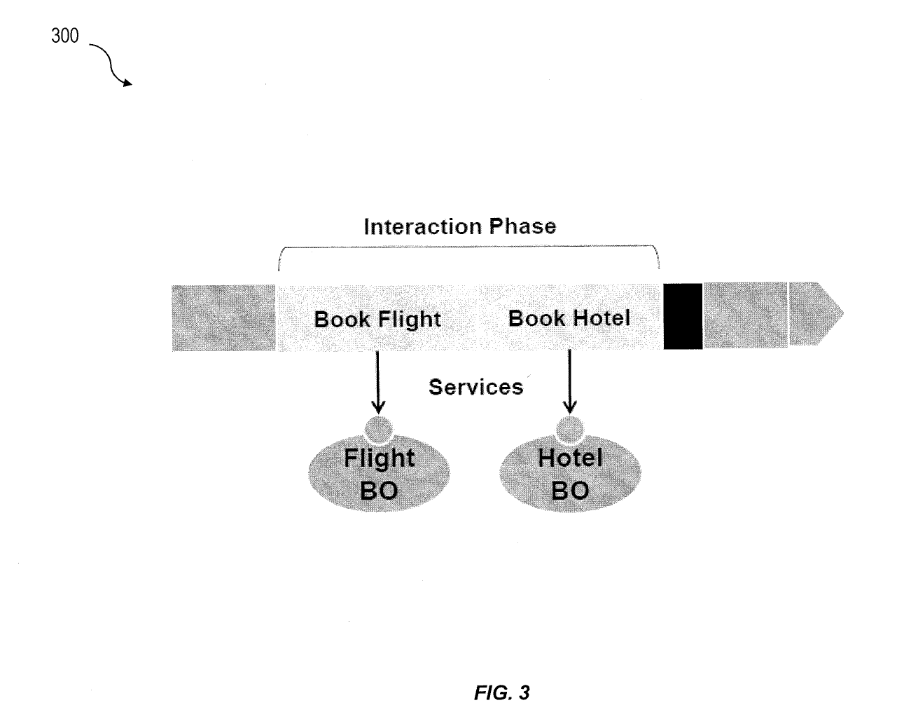

FIG. 2 is a diagram 200 that illustrates a transaction that comprises a set of indivisible operations that must be executed together in order to ensure completeness. In particular, diagram 200 illustrates a travel transaction in which, during an interaction phase, both a flight and a hotel need to be booked. With reference to the diagram 300 of FIG. 3, the interaction phase involves changing one or more values to both a flight business object and a hotel business object. The services provided by these business objects can be described by a generic service interface (i.e., all business objects can be accessed via the same interface).

Referring again to the diagram 200 of FIG. 2, once this transaction is completed, the changes are either saved or cleaned up during a subsequent phase (sometimes referred to as a save/cleanup phase). Cleanup can be required when changes to at least one of the business objects implicated by the transaction is not saved such as when a transaction is terminated prior to completion. Cleanup involves reverting any changed values to their previous state.

A transaction can require one or more business object services executed via the corresponding business object interfaces. These business object services can include, but are not limited to:

RETRIEVE—This service is used to read node instances of a node of a business object. The service request specifies the node IDs of the elements for which the data shall be read.

RETRIEVE_BY_ASSOCIATION—This service is used to read the instances of the target node of an association, which are related to a given set of node IDs of the source node.

EXECUTE_ACTION—This service is used to execute an action of a business object on a given set of node instances.

MODIFY—This service is used to create, update or delete the node instances of a node of a business object.

QUERY—This service is used to get node IDs of node instances which fit to the query condition.

CHECK/CHECK_AND_DETERMINE—This service is used to check if a node or node tree is in a consistent state or not. The service can return messages in order to describe inconsistent states.

CONVERT_KEYS/CONVERT_KEY_TO_NODE_ID—This service is used to convert alternative keys (e.g. ISBN number) to technical node instance keys.

Accessing Business Objects. If an external consumer would like to access business objects via, for example, reports, the following step can be performed:

1. Get an instance of the ACP

DATA(lo_acp)=cl_esf_acp_factory=>get_acp( ).

2. Call the desired business object service (for instance RETRIEVE)

DATA(lt_root)=bo_esm2_sales_order=>root=>retrieve(VALUE #((lv_root_node_id))).

3. Save (or cleanup) the transaction

lo_acp→save_transaction( ).

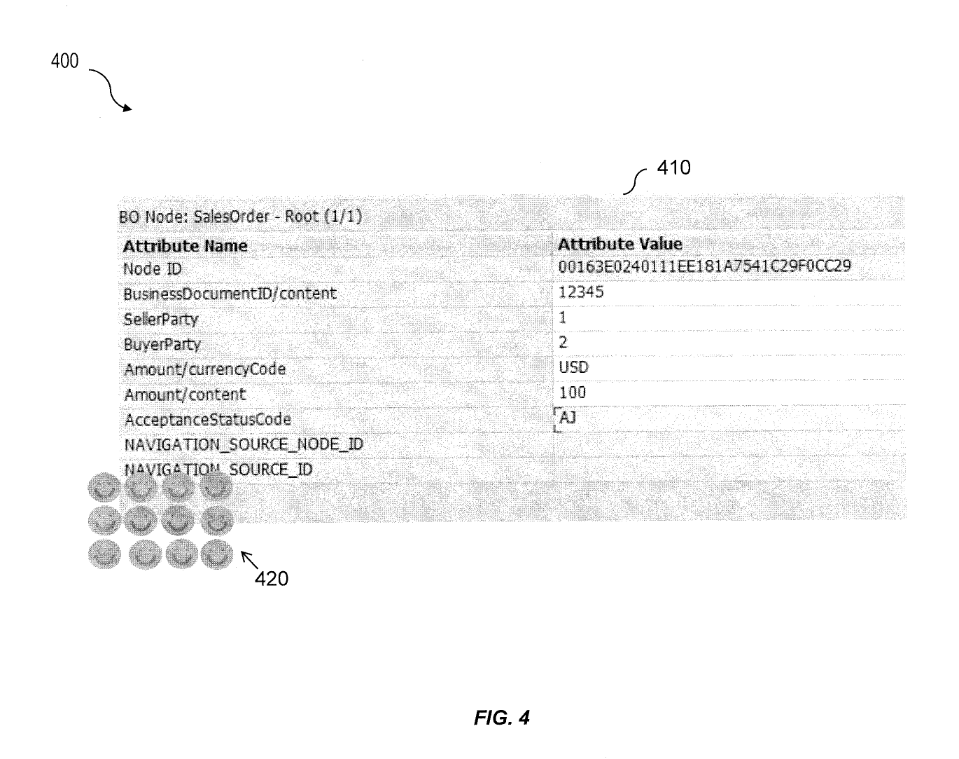

FIG. 4 is a diagram 400 illustrating an interface 410 representing various values encapsulated in a business object (in particular—a node of a SalesOrder business object). For example, a plurality of users 420 can, via the interface 410, concurrently view and edit various values for sales order number 123456. With such cases, the values in the fields of the interface 410 can be edited by more than one user. As will be described in more detail below, if several users are executing their modifications at the same time, the changes implemented by a first user 420 to complete a transaction are implemented and the other users are notified.

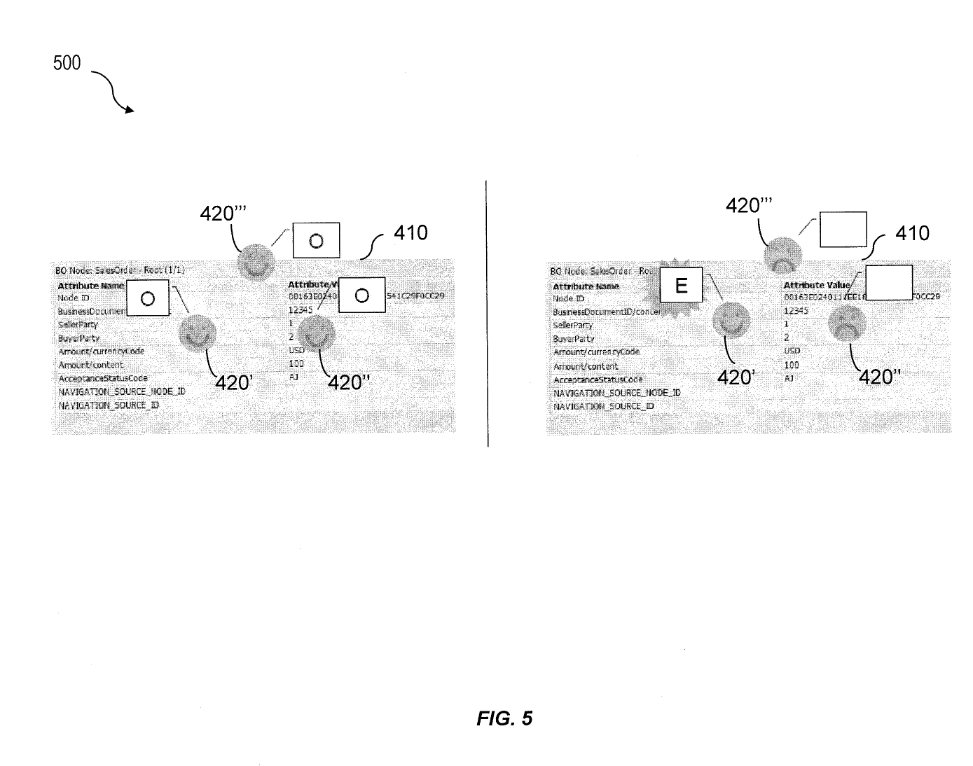

FIG. 5 is a diagram illustrating two views of interface 410. As illustrated, several users (420′, 420″, 420′″) can acquire optimistic locks (“O”) for the same business object instance and afterwards reading (and start editing values of the business object via the interface 410) in parallel. Optimistic locks, in this regard, have no effect until the corresponding transaction is completed or terminated—but are indicators of a potential exclusive lock. As soon as a first user 420′ acquires an exclusive lock (“E”), all other users 420″, 420′″ lose their optimistic locks for that business object instance. For example, if the first user 420′ executes the modify update core service in order to forward his/her changes to a backend system. The users 420″, 420′″ that lose their optimistic locks can be notified as soon as a next core service call is executed. In some implementations, an error message can be displayed indicating that the user's changes will not be saved, a conflict exists, and/or the values in the interface 410 can be updated to reflect changes made as part of the transaction given the exclusive lock. At this point, the users 420″, 420″ are no longer able to obtain an exclusive lock on the business object.

Locks on a business object can be acquired via various mechanisms. For example, locks can be automatically set by the enterprise services framework 130 as soon as a modifying core service is executed. In some scenarios/implementations, there can be a requirement to explicitly set an exclusive lock on a certain node instance. This can be done, for example, via method RETRIEVE with parameter EDIT_MODE.

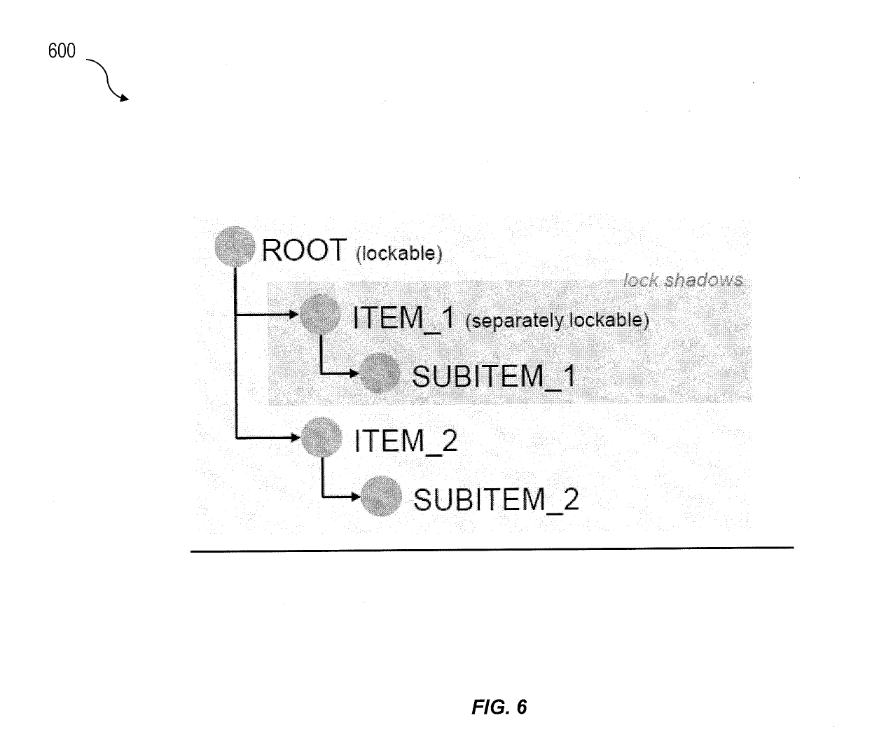

Locks on a business object can be released via various mechanisms. If the transaction ends with a CLEANUP operation (i.e., a reversion to previous values, etc.), all locks on the particular business object are released. In cases in which the transaction ends with a SAVE operation (i.e., the values added/modified are saved, etc.), all optimistic locks assigned to other users are released. In addition, in cases in which there are multiple exclusive locks (see FIG. 6 and accompanying text below) all exclusive locks can be transformed to optimistic locks—thus the user interface 410 is able to keep the fields editable.

In some cases, business processes can require partial locking of a business object instance. Metadata associated with a business object (stored, for example, in a metadata repository) can indicate whether a node of such business object is separately lockable. The enterprise services framework 130 can consume such metadata for locking purposes.

With partial locking, a lock shadow can be defined as a group of nodes that is always locked together regarding their composition relations. Stated differently, if one of the nodes in the lock shadow is to be locked then all nodes are locked. Every separately lockable node creates a new lock shadow containing the node itself and all subnodes regarding the composition tree that are not separately lockable on their own. Every node can only be part of exactly one lock shadow.

With reference to the diagram 600 of FIG. 6, a lock request for an instance in SUBITEM_1 can result in the locking of the parent instance in ITEM_1 and with this all corresponding child instances in SUBITEM_1. In addition, a lock request for an instance in SUBITEM_2 can result in the locking of the ROOT instance and with this all belonging child (apart from child instances belong to ITEM_1 and SUBITEM_1).

One example of a lock shadow comes into play with a pick list used by a warehouse worker to pick all items required for a certain delivery. The corresponding business object for the pick list has a header and a list of items to be picked. As soon as an item is picked a corresponding status is changed on the item and the picked quantity is stored. The picking of different items can be done in parallel because the corresponding nodes of the business object are separately lockable and therefore it should also be possible to confirm the picking in parallel.

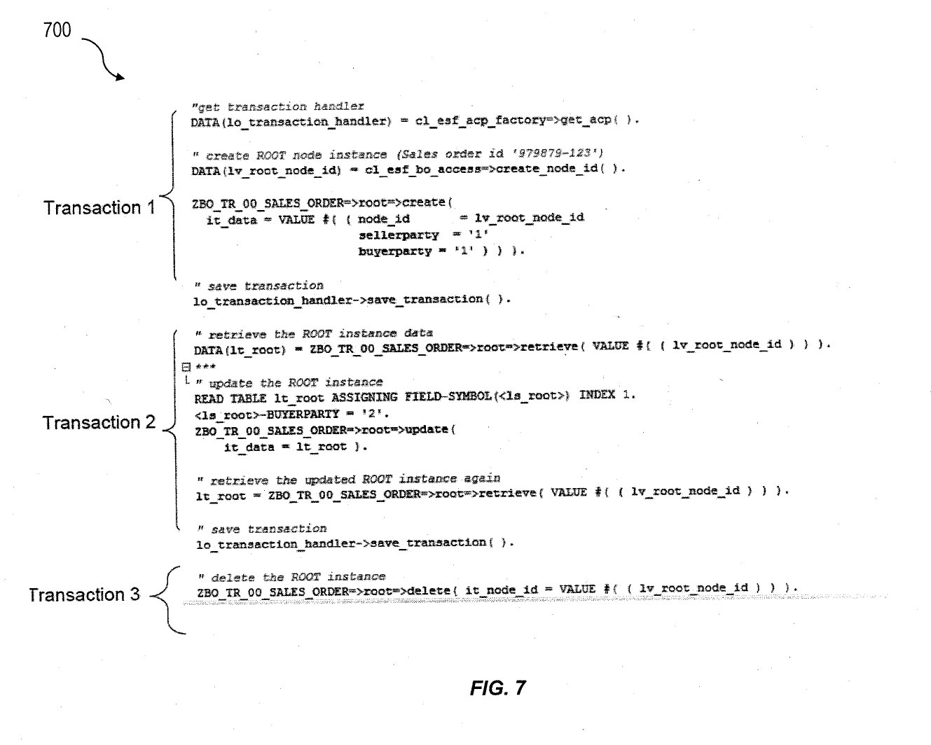

FIG. 7 illustrates code 700 for three separate transactions written in order to create a new sales order instance, update and delete it. This code 700 shows an API for external consumers accessing the business object.

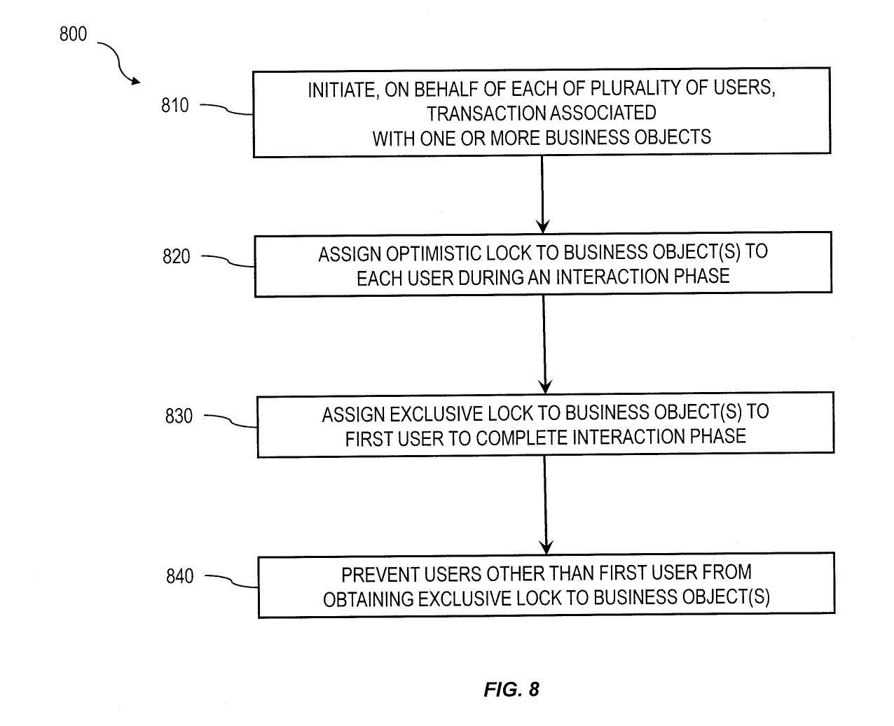

FIG. 8 is a process flow diagram 800 illustrating a method in which, at 810, transactions associated with at least one business object are initiated on behalf of each of a plurality of users during an interaction phase. Each business object comprises a plurality of hierarchically related nodes storing data values. At least two of the transactions are concurrently executed and are initiated via a service interface of the at least one business object. Each transaction comprises a set of operations that are required to be executed together in which at least one of the operations require modification of the at least one business object. Subsequently, at 820, upon modification of at least one node of the at least one business object, an optimistic lock to the business object is assigned to each user during pendency of the corresponding transaction. Thereafter, at 830, an exclusive lock to the at least one business object is assigned to a first user that first completes the interaction phase. Once this exclusive lock has been assigned, at 840, each user other than the first user is prevented from obtaining an exclusive lock to the at least one business object. In some optional variations, data is provided to each such user characterizing that the exclusive lock has been assigned to the at least one business object.

Various implementations of the subject matter described herein may be realized in digital electronic circuitry, integrated circuitry, specially designed ASICs (application specific integrated circuits), computer hardware, firmware, software, and/or combinations thereof. These various implementations may include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and may be implemented in a high-level procedural and/or object-oriented programming language, functional programming language, logical programming language, and/or in assembly/machine language. As used herein, the term “machine-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the subject matter described herein may be implemented on a computer having a display device (e.g., a CRT (cathode ray tube) or LCD (liquid crystal display) monitor) for displaying information to the user and an interface such as a touch screen and/or a keyboard and a pointing device (e.g., a mouse or a trackball) by which the user may provide input to the computer. Other kinds of devices may be used to provide for interaction with a user as well; for example, feedback provided to the user may be any form of sensory feedback (e.g., visual feedback, auditory feedback, or tactile feedback); and input from the user may be received in any form, including acoustic, speech, or tactile input.

The subject matter described herein may be implemented in a computing system that includes a back-end component (e.g., as a data server), or that includes a middleware component (e.g., an application server), or that includes a front-end component (e.g., a client computer having a graphical user interface or a Web browser through which a user may interact with an implementation of the subject matter described herein), or any combination of such back-end, middleware, or front-end components. The components of the system may be interconnected by any form or medium of digital data communication (e.g., a communication network). Examples of communication networks include a local area network (“LAN”), a wide area network (“WAN”), and the Internet.

The computing system may include clients and servers. A client and server are generally remote from each other and typically interact through a communication network. The relationship of client and server arises by virtue of computer programs running on the respective computers and having a client-server relationship to each other.

Although a few variations have been described in detail above, other modifications are possible. For example, the logic flow depicted in the accompanying figures and described herein do not require the particular order shown, or sequential order, to achieve desirable results. Other embodiments may be within the scope of the following claims.

What is claimed is:

1. A method comprising:
initiating, on behalf of each of a plurality of users during an interaction phase, a respective transaction associated with at least one business object, each business object comprising a plurality of hierarchically related nodes storing values, each transaction being initiated via a service interface of the at least one business object and comprising a set of operations that are required to be executed together, at least one of the operations requiring modification of the at least one business object;
assigning, upon modification of at least one node of the at least one business object, an optimistic lock to the business object to each user during pendency of the corresponding transaction;
assigning an exclusive lock to the at least one business object to a first user that first completes the interaction phase; and
preventing users other than the first user from obtaining an exclusive lock to the at least one business object in response to the exclusive lock being assigned.

2. A method as in claim 1, further comprising:
providing data to each user having an assigned optimistic lock other than the first user that indicates that an exclusive lock has been assigned.

3. A method as in claim 2, wherein the providing data comprises displaying a message to each user having an assigned optimistic lock other than the first user.

4. A method as in claim 1, wherein the interaction phase is completed when results of business object services executed during the interaction phase via the service interface are saved.

5. A method as in claim 1, further comprising:
releasing all optimistic and exclusive locks, if any, when the results of the business object services are saved.

6. A method as in claim 1, wherein the interaction phase is completed when results of business object services executed during the interaction phase via the service interface are cleaned up.

7. A method as in claim 1, wherein any other exclusive locks are transformed to optimistic locks.

8. A method as in claim 1, wherein at least one of the optimistic locks is for a subset of the nodes of the business object with the other nodes of the at least one business object not being locked.

9. A method as in claim 8, wherein each business object has an associated at least one lock shadow, each lock shadow defining a group of at least two nodes that must be concurrently locked.

10. A method as in claim 1, wherein the transaction is associated with two or more business objects.

11. A non-transitory computer program product storing instructions which, when executed by at least one data processor, result in operations comprising:
initiating, on behalf of each of a plurality of users during an interaction phase, a respective transaction associated with at least one business object, each business object comprising a plurality of hierarchically related nodes storing values, each transaction being initiated via a service interface of the at least one business object and comprising a set of operations that are required to be executed together, at least one of the operations requiring modification of the at least one business object;
assigning, upon modification of at least one node of the at least one business object, an optimistic lock to the business object to each user during pendency of the corresponding transaction;
assigning an exclusive lock to the at least one business object to a first user that first completes the interaction phase; and
preventing users other than the first user from obtaining an exclusive lock to the at least one business object in response to the exclusive lock being assigned.

12. A computer program product as in claim 11, wherein the operations further comprise:
providing data to each user having an assigned optimistic lock other than the first user that indicates that an exclusive lock has been assigned.

13. A computer program product as in claim 12, wherein the providing data comprises displaying a message to each user having an assigned optimistic lock other than the first user.

14. A computer program product as in claim 11, wherein the interaction phase is completed when results of business object services executed during the interaction phase via the service interface are saved.

15. A computer program product as in claim 11, further comprising:
releasing all optimistic and exclusive locks, if any, when the results of the business object services are saved.

16. A computer program product as in claim 11, wherein the interaction phase is completed when results of business object services executed during the interaction phase via the service interface are cleaned up.

17. A computer program product as in claim 11, wherein any other exclusive locks are transformed to optimistic locks.

18. A computer program product as in claim 11, wherein at least one of the optimistic locks is for a subset of the nodes of the business object with the other nodes of the at least one business object not being locked.

19. A computer program product as in claim 18, wherein each business object has an associated at least one lock shadow, each lock shadow defining a group of at least two nodes that must be concurrently locked; and wherein the transaction is associated with two or more business objects.

20. A system comprising:
at least one data processor; and
memory storing instructions which, when executed by the at least one data processor, result in operations comprising:
initiating, on behalf of each of a plurality of users during an interaction phase, a respective transaction associated with at least one business object, each business object comprising a plurality of hierarchically related nodes storing values, each transaction being initiated via a service interface of the at least one business object and comprising a set of operations that are required to be executed together, at least one of the operations requiring modification of the at least one business object;
assigning, upon modification of at least one node of the at least one business object, an optimistic lock to the business object to each user during pendency of the corresponding transaction;
assigning an exclusive lock to the at least one business object to a first user that first completes the interaction phase; and
preventing users other than the first user from obtaining an exclusive lock to the at least one business object in response to the exclusive lock being assigned.
